(19) United States
(12) Patent Application Publication
(10) Pub. No.: US 2003/0003972 A1
(43) Pub. Date: Jan. 2, 2003

(54) Mobile communication device emergency power management method and apparatus

(76) Inventor: Sami Sabat, San Diego, CA (US)

Correspondence Address: MILAN I. PATEL, NOKIA, INC., 6000 CONNECTION DRIVE, MD 1-4-755, IRVING, TX, 75039, US

(21) Appl. No.: 09/896,222

(22) Filed: Jun. 29, 2001

(51) Int. Cl. H04M 1/00

(52) U.S. Cl. 455/574; 455/404

(57) ABSTRACT

The present invention relates to a system and method for reserving enough battery power in a mobile communication device to make emergency calls. The invention additionally relates to a system and method to restrict the user if necessary to a set of emergency numbers when there is limited power available to the mobile communication device.

### FIELD OF INVENTION

The present invention relates to power management in a mobile communication device and more particularly to a system for managing power in a mobile communication device for emergency purposes.

### BACKGROUND

As the mobile information society grows, there is an increasing demand for mobile phones and other mobile communication devices. As the physical size of mobile phones and costs for these devices shrink, their proliferation in our society will sharply increase. Proliferation is not narrowly focused to certain market segments, but rather more evenly distributed among many diverse markets. Our society is becoming increasingly dependent on these portable communication devices for business, socializing, entertainment and most importantly for the security they provide. For example, parents want their children to have a mobile phone handy especially in an emergency and want to be able to contact them regardless of their location and know that they are safe. Likewise, senior citizens are carrying mobile phone in increasing numbers primarily because of the security they provide.

One common requirement among all mobile communication devices is readily available battery power lasting as long as possible. Rechargeable batteries that easily connect to mobile phones and provide for many hours of air-time are common. But regardless of how long a particular manufacturer's battery lasts, it will eventually dissipate and cease to provide the mobile communication device with sufficient power. When battery power has been used completely, the mobile communication device will not operate until the battery is recharged or replaced. Generally, it's a minor inconvenience to a user if the user is not able to use the mobile communication device due to lack of battery power when used for social or entertainment reasons. However, it is very inconvenient and possibly life threatening if the user is not able to use the mobile communication device in case of an emergency. It is especially inconvenient for user of the mobile communication device to manually manage the battery power to insure that electronic device will be operable if need for emergency.

Since safety is your most important call and your least expected call to make, it would be wise to include functionality on the mobile communication device to intelligently manage power such that power would always be available in the event of an emergency. Existing mobile phones show available battery power to the user, but do not provide a means for saving minimum battery power to make emergency calls in the event of a true emergency.

Therefore, it would be useful if a method was provided that would reserve minimum battery power to make an emergency call.

### SUMMARY

The present invention advantageously provides a system and a method in an electronic device, such as a mobile terminal, for reserving enough battery power to make emergency calls. The method further provides the user with an indication when there is only enough available power to make emergency calls. When a user is aware that only enough power exists to make emergency calls, the cautious user will refrain from making calls for entertainment or convenience purposes in case of an unexpected emergency. The invention additionally provides for a system and method to restrict the user, if necessary, to making and receiving emergency calls when there is limited power available to the mobile communication device. Once the battery power reaches a minimum threshold, the electronic device may be restricted to use a set of pre-programmed phone numbers, such as “911” for US or other emergency numbers. For example, a parent or employer may choose to restrict calls for a child or employee, respectively, to a set of emergency pre-programmed numbers when only minimal battery power is available.

A more complete appreciation of all the advantages and scope of the present invention can be obtained from the accompanying drawings, the following detailed description of the invention, and the appended claims.

### BRIEF DESCRIPTION OF THE DRAWINGS

FIG. 1 illustrates a block diagram of a mobile communication device into which an embodiment of the invention may be implemented.

FIG. 2 illustrates a mobile communication device and a second communication device linked by a network.

FIG. 3 illustrates a mobile communication device battery pack comprising a primary and secondary power source.

FIG. 4 illustrates a method for determining when to switch from a primary power source to a secondary power source when a connection exists.

FIG. 5 illustrates a method for determining when to switch from a primary power source to a secondary power source when a request to establish a connection is received.

FIG. 6 illustrates an embodiment of the invention comprising a method for managing power on a mobile communication device.

FIG. 7 illustrates a method of optionally restricting calls by the mobile communication device to a pre-programmed set of at least one subscriber number.

### DETAILED DESCRIPTION

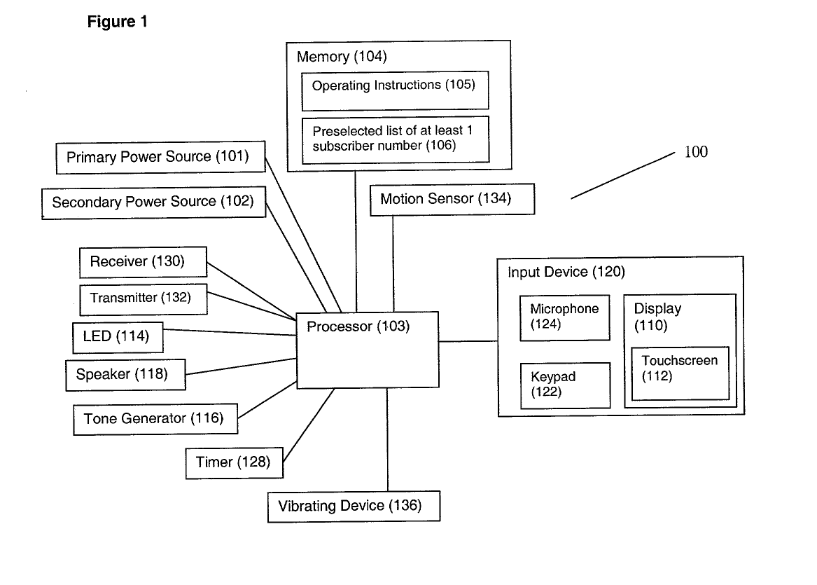

FIG. 1 illustrates a block diagram of a mobile communication device 100, according to an embodiment of the invention. Generally, the mobile communication device 100 includes a processor 103 (which may also be known as a controller) coupled to various memories, collectively shown as memory 104. Memory 104 includes a plurality of stored constants and variables that are used by processor 103 during the operation of the mobile communication device 100. For example, memory 104 stores the values of the various feature parameters. Memory 104 is also used to store data provided by the user through the user interface. Operating instructions 105 for controlling the operation of processor 103 are also stored in memory 104. In several embodiments of the invention, the methods comprise operating instructions stored in memory 104 and are executed by processor 103. Based on these operating instructions, processor 103 may control various resources and peripherals such as primary power source 101, secondary power source 102, memory 104, input device 120, receiver 130, transmitter 132, LED 132, speaker 118, tone generator 116, timer 128, vibrating device 136 and motion sensor 134.

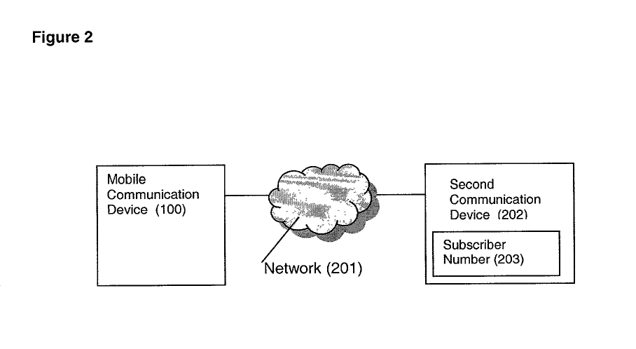

FIG. 2 illustrates a mobile communication device 100 and a second communication device 202 linked by a network 201. A mobile communication device 100 comprises a memory 104 which includes a pre-selected list of at least one subscriber number 106 as shown in FIG. 1. A second communication device 202 comprises a subscriber number 203.

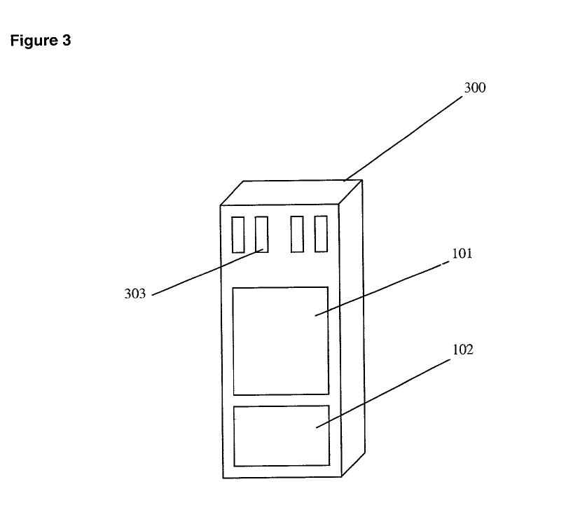

FIG. 3 illustrates a battery pack arrangement 300 for an electronic device, for example the mobile communication device 100, according to an embodiment of the invention. The battery pack arrangement 300 generally comprises a primary power source 101, a secondary power source 102, and battery pack arrangement contacts 303 that electrically connects the battery pack arrangement 300 to an electronic device such as a mobile communication device 100. In an embodiment of the invention, both the primary power source 101 and secondary power source 102, each may be separately or directly connected to the electronic device. According to an embodiment of the invention, both the primary power source 101 and secondary power source 102 may be used independently as power sources for the mobile communication device. The primary power source 101 is capable of storing enough power to enable the mobile communications device to operate normally for as long as possible. The secondary power source 102 is also capable of storing enough power to enable the mobile communications device to operate for as long as possible but according to an embodiment of the invention the secondary battery may store enough power to allow minimum mobile communication device functionality including the placing and receiving emergency phone calls. According to an embodiment of the invention, the primary power source 101 and secondary power source 102 may each comprise a battery electrically connected with the mobile communication device 100.

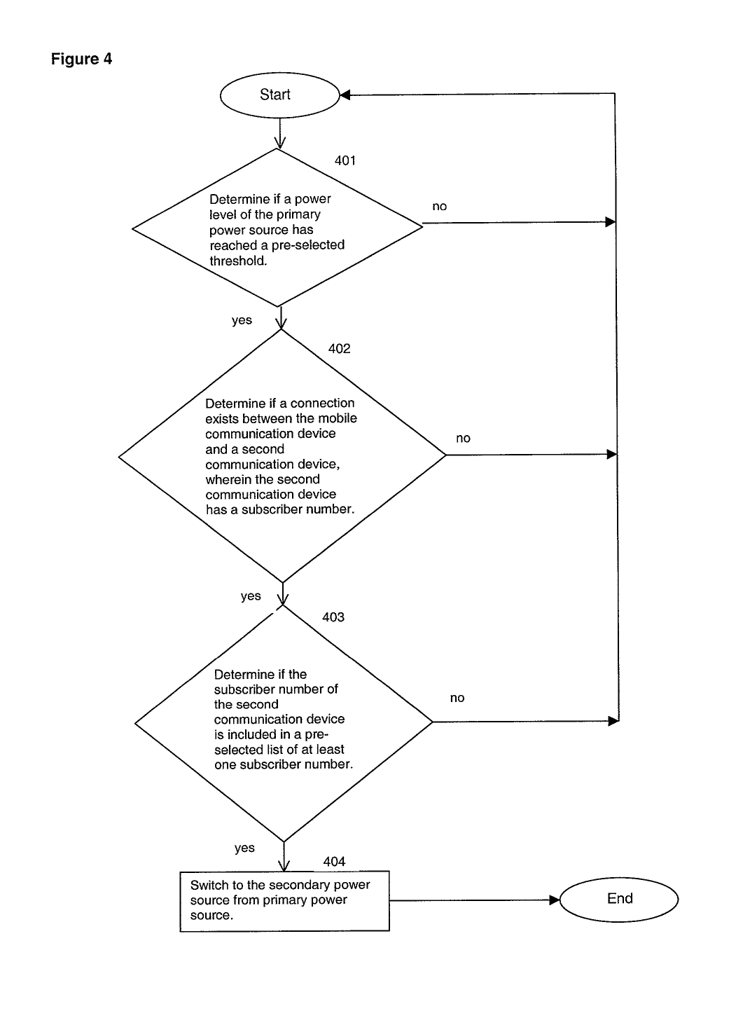

FIG. 4 illustrates a method for managing the available power on a mobile communication device according to an embodiment of the invention. More specifically, FIG. 4 illustrates a method for determining when to switch from primary power source 101 to a secondary power source 102 when a connection exists. In an embodiment of the invention, the method comprises operating instructions that are stored in memory 104 and are executed by processor 103. Generally, at block 401, the method determines if the power level of the primary power source 101 has reached a pre-selected threshold. If yes, then at block 402, the method determines if a connection exists between the mobile communication device 100 and a second communication device 202. If yes, then at block 403, the method determines if the subscriber number 203 of the second communication device 202 is included in a pre-selected list of subscriber numbers 106. If yes, then at block 404, the method switches the mobile communication device 100 from primary power source 101 to a secondary power source 102.

The pre-selected threshold in block 401 may be received in the mobile communication device by pre-selecting or pre-programming by the manufacturer or by the user. The pre-selected threshold may be received by the mobile communication device 100 from a second mobile communications 202 device or from a communications device manager over a communication path.

The connection in block 402 may be a one-way or two-way communication between the mobile communication device 100 and the second communication device 202.

The subscriber number 203 in block 402 or block 403 may be any alphanumeric sequence such as a phone number, serial number, communications device identification, or other alpha-numeric sequence that uniquely identifies the second communication device 202.

The pre-selected list of at least one subscriber number 106 in block 403 may exist within the mobile communications device 100, on a second communications device 202 or on a server. The list may be programmed by a user or a manufacturer.

In block 404, according to an embodiment of the invention the switch to the secondary power source 102 from the primary power source 101 may take place automatically within the mobile communications device 100. According to an alternative embodiment, the switch may be initiated manually by the user.

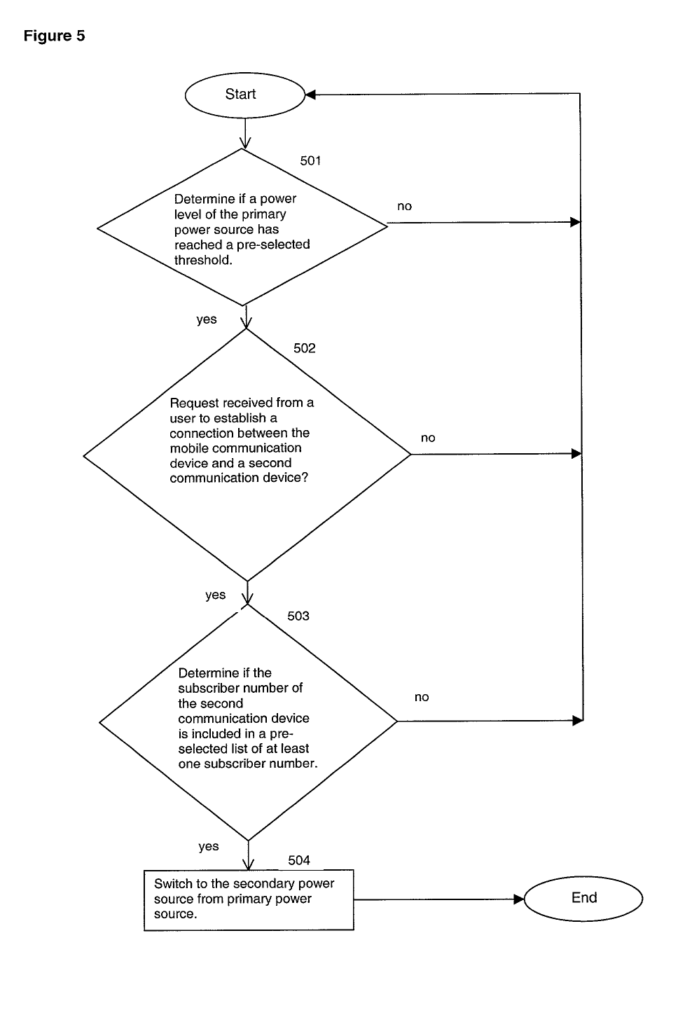

FIG. 5 illustrates a method for managing the available power on the mobile communication device 100 using two power sources: a primary power source 101 and a secondary power source 102. More specifically, FIG. 5 illustrates a method for determining when to switch from a primary power source to a secondary power source when a connection request is received. In an embodiment of the invention, the method comprises operating instructions that are stored in memory 104 and are executed by processor 103. According to FIG. 5, three requirements must be met before switching from a primary power source 101 to a secondary power source 102: the power level of the primary power source 101 has reached a pre-selected threshold according to block 501, a request is received by the mobile communication device 100 to establish a connection between a mobile communication device 100 and a second communication device 202 according to block 502 and the subscriber number 203 on the second communication device 202 is included in a pre-selected list of at least one subscriber number 104 according to block 503.

In one embodiment of the invention the request in block 502 may originate from a user to establish a connection between a mobile communication device 100 and a second communication device 202. In another embodiment of the invention the request may originate internally from within the mobile communication device 100. For example, software located within the mobile communication device 100 may initiate the request in block 502 based on a timer preset by a user.

The pre-selected threshold in block 501 may be received in the mobile communication device 100 by pre-selecting or pre-programming by the manufacturer or by the user. The pre-selected threshold may be received by the mobile communication device 100 from a second communications device 202 or from a communications device manager over a communication path.

The subscriber number 203 in block 503 may be any alphanumeric sequence such as a phone number, serial number, communications device identification, or other alphanumeric sequence that uniquely identifies the second communication device.

The pre-selected list of at least one subscriber number 106 in block 503 may exist within the mobile communications device 100, on a second communications device 202 or on a server. The list may be programmed by a user or a manufacturer.

In one embodiment of the invention, the processor 103 provides a means for switching from the primary power source 101 to the secondary power source 102 when the processor 103 determines that the power level on the primary power source 101 has reached a pre-selected threshold while a connection exists between the mobile communication device 100 and a second communication device 202.

In an alternative embodiment of the invention, the processor 103 provides a means for switching from the primary power source 101 to the secondary power source 102 when the processor 103 determines that the power level on the primary power source 101 has reached a pre-selected threshold and when a connection is initiated using a subscriber number, wherein the subscriber number is located in a pre-selected list of at least one subscriber number 106 on the mobile communication device 100.

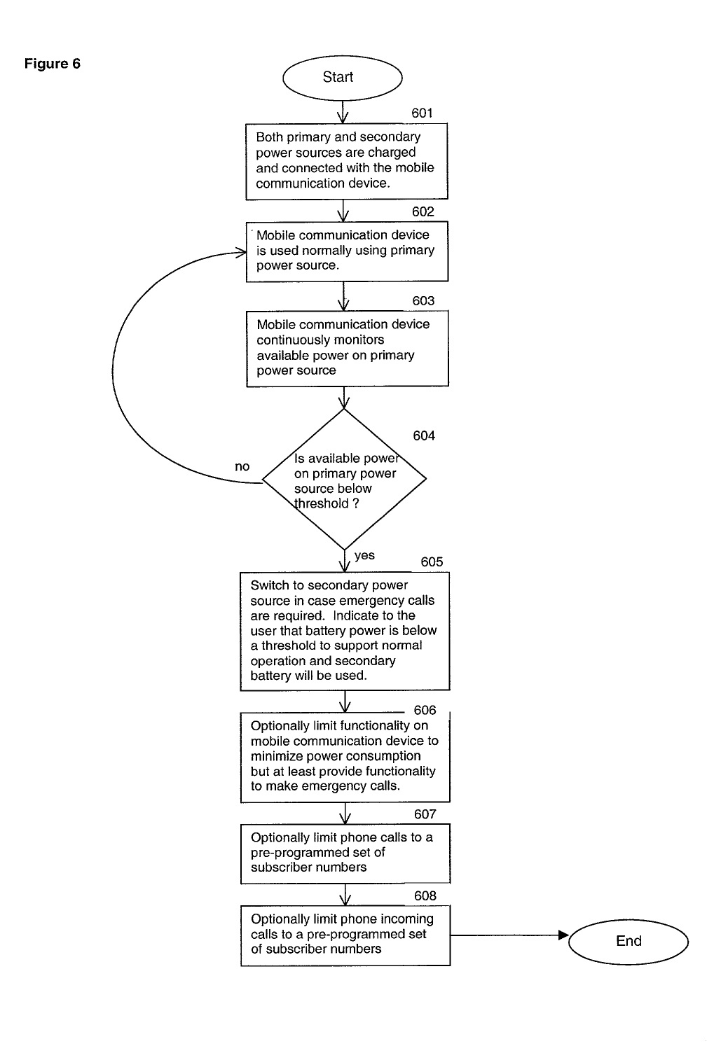

FIG. 6 illustrates an embodiment of the invention comprising a method for managing power on a mobile communication device 100. In an embodiment of the invention, the method comprises operating instructions that are stored in memory 104 and are executed by processor 103. Once the primary power source 101 and secondary power source 102 have been charged and connected with the mobile communication device, according to block 601 the device may be used by a user with unrestricted access to normal functionality. Normal functionality of a mobile communication device may include but is not limited to: placing and receiving phone calls, text messaging such as sending and receiving emails and paging. According to block 602, power is received by the mobile communication device 100 during normal operation from the primary power source 101. According to block 603, the mobile communication device 100 continuously monitors available power on the primary power source 101. According to block 604, if the available power on the primary power source 101 is not below a threshold, then the user may continue to use the mobile communication device normally. The threshold described herein is typically but not necessarily the quantity of power required by the mobile communication device from the primary power source 101 to allow normal operation of the device. According to an embodiment of the invention, this threshold may be variable and may be pre-programmed by the manufacturer of the mobile communication device or the user. However, if the available power on the primary power source 101 is below a threshold, perform block 605. In block 605, the mobile communication device 100 switches from the primary power source 101 to the secondary power source 102 in case emergency calls are required. In block 606, the mobile communication device 100 may limit the functionality available to the user to conserve power in case the device must be used in an emergency. For example, the functionality of the mobile communication device 100 may be limited to placing or receiving a call wherein the call is associated with the pre-selected list of subscriber numbers. It should be noted that other limitation may be added by the user or the manufacturer of the mobile communication device 100 without departing from the invention. In block 607, phone calls made from the mobile communication device 100 may be limited by the device to a pre-programmed set of emergency numbers. In block 608, incoming phone calls from a second communication device 202 are accepted if the second communication device subscriber number 203 is located in pre-selected list of at least one subscriber number 106 located on the mobile communication device 100.

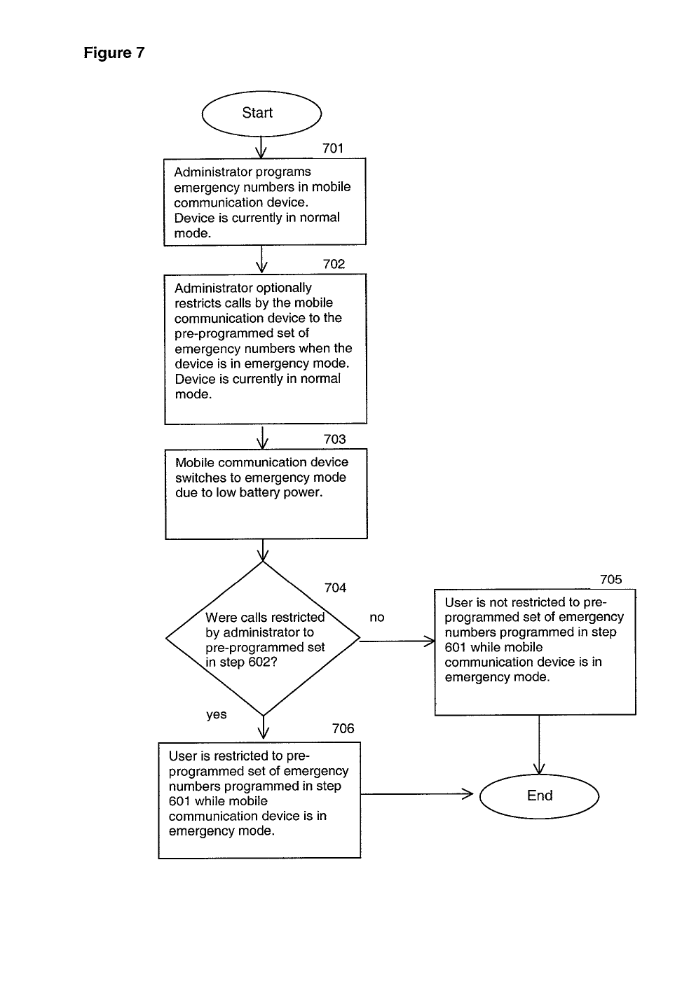

FIG. 7 illustrates a method of optionally restricting incoming or outgoing calls by the mobile communication device to a pre-selected list of at least one subscriber number 106. In an embodiment of the invention, the method comprises operating instructions that are stored in memory 104 and are executed by processor 103. In block 701, an administrator programs a set of emergency subscriber numbers into the mobile communication device 100 during normal mode. In normal mode the mobile communication device 100 operates normally providing all available functionality to the user. The administrator may be the owner of the mobile communication device 100 or one who has authority from the owner of the device to add, edit and delete phone numbers from the emergency set of phone numbers. For example, the administrator may be a parent of a child who uses the mobile communication device 100 for security. In block 702, the administrator may configure the device to restrict incoming or outgoing calls when the device is in emergency mode to the pre-programmed set of at least one emergency number programmed in block 701. In the emergency mode, the mobile communication device 100 has limited available power sufficient to place and receive emergency calls and possibly provide some other minimal device functionality. In block 703, the mobile communication device 100 switches to emergency mode due to power reaching a pre-selected threshold on the primary power source 101. In block 704, if calls were restricted in block 702 by the administrator to the pre-selected list of at least one emergency number 106, then perform block 706. In block 704, if calls were not restricted in block 702 by the administrator to the pre-selected list of emergency phone numbers, then perform block 705. In block 705, the user is not restricted by the mobile communication device to the pre-selected list of emergency numbers 106 while in emergency mode. In block 706, the user is restricted to the pre-selected list of emergency numbers programmed in block 701 in case an emergency call is required while the mobile communication device is in emergency mode.

From the foregoing description, it will be evident that there are a number of changes, adaptations and modifications of the present invention which come within the province of those skilled in the art. However, it is intended that all such variations not departing from the spirit of the invention be considered as within the scope thereof as limited solely by the claims appended thereto.

What is claimed is:

1. A method of managing electric power of a mobile communication device, the mobile communication device being powered by a primary power source and a secondary power source, said method comprising the steps of:
determining if a power level of the primary power source has reached a pre-selected threshold;
determining if a connection exits between the mobile communication device and a second communication device, wherein said second communication device having a subscriber number;
determining if said subscriber number of said second communication device is included in a pre-selected list of at least one subscriber number; and
switching to the secondary power source from the primary power source if determined that said power level on the primary power source has reached below said pre-selected threshold when said connection exists between the mobile communication device and said second mobile communication device, wherein said subscriber number of said second mobile communication device is included in said pre-selected list of at least one subscriber number.

2. A mobile communication device as in claim 1; wherein said mobile communication device is a mobile phone, PDA (Personal Digital Assistant), pager or laptop computer.

3. A mobile communication device as in claim 1; wherein said primary power source is a battery.

4. A mobile communication device as in claim 1; wherein said secondary power source is a battery.

5. A method of managing electric power on a mobile communication device having a primary power source and a secondary power source, said method comprising the steps of:
determining if a power level of the primary power source has reached a pre-selected threshold;
receiving a request to establish a connection between the mobile communication device and a second communication device, wherein said second mobile communication device having a subscriber number;
determining if said subscriber number of said second mobile communication device is included in a pre-selected list of at least one subscriber number; and
switching to the secondary power source from the primary power source if determined that said power level on the primary power source has reached below a pre-selected threshold and during said request to establish said connection between the mobile communication device and said second mobile communication device wherein said subscriber number of said second mobile communication device is included in said pre-selected list of at least one subscriber number.

6. A mobile communication device as in claim 5; wherein said mobile communication device is a mobile phone, PDA (Personal Digital Assistant), pager or laptop computer.

7. A mobile communication device as in claim 5; wherein said primary power source is a battery.

8. A mobile communication device as in claim 5; wherein said secondary power source is a battery.

9. The method as in claim 5; wherein said step of receiving a request to establish a connection between the mobile communication device and a second communication device, wherein said second mobile communication device having a subscriber number further includes receiving said request from a user or a management station.

10. The method as in claim 5 further comprising the step of optionally further limiting functionality on said mobile communication device to minimize power consumption.

11. A mobile communication device powered by a primary power source and a secondary power source, the mobile communication device comprising:
a primary power source;
a secondary power source;
a processor for managing said primary power source and said secondary power source; wherein said processor switches to said secondary power source from said primary power source when processor determines that power level of the primary power source has reached a pre-selected threshold while a connection exists between the mobile communication device and a second communication device having a subscriber's number, wherein the subscriber number of said second communication device is included in a pre-selected list of at least one subscriber number.

12. A mobile communication device as in claim 11; wherein said mobile communication device is a mobile phone, PDA (Personal Digital Assistant), pager or laptop computer.

13. A mobile communication device as in claim 11; wherein said primary power source is a battery.

14. A mobile communication device as in claim 11; wherein said secondary power source is a battery.

15. A mobile communication device apparatus comprising:
a primary power source;
a secondary power source;
a processor for managing said primary power source and said secondary power source, wherein said processor switches to said secondary power source from said primary power source when processor determines that power level on said primary power source has reached a threshold and when said mobile communication device initiates a call using a subscriber number, wherein said subscriber number is located in a list of at least one subscriber number on said mobile communication device.

16. A mobile communication device as in claim 15; wherein said mobile communication device is a mobile phone, PDA (Personal Digital Assistant), pager or laptop computer.

17. A mobile communication device as in claim 15; wherein said primary power source is a battery.

18. A mobile communication device as in claim 15; wherein said secondary power source is a battery.
